(19) United States
(12) Patent Application Publication
(10) Pub. No.: US 2002/0059098 A1
(43) Pub. Date: May 16, 2002

(54) Method for managing an imaginary store, method for using the imaginary store, and recording medium in which an imaginary store managing program is stored

(76) Inventors: Shinichi Sazawa, Kawasaki (JP); Yuichi Sato, Kawasaki (JP); Masayoshi Hashima, Kawasaki (JP); Yosuke Senta, Kawasaki (JP)

Correspondence Address: STAAS & HALSEY LLP, 700 11TH STREET, NW, SUITE 500, WASHINGTON, DC, 20001, US

(21) Appl. No.: 09/788,486

(22) Filed: Feb. 21, 2001

(30) Foreign Application Priority Data
Nov. 16, 2000 (JP) 2000-349402

(51) Int. Cl. G06F 17/60

(52) U.S. Cl. 705/14; 705/27

(57) ABSTRACT

An imaginary store is displayed in response to client's request. Correspondingly to selection of a product object by the client in the imaginary store, a chat channel between the client and a salesperson is set up. Data on characters in the chat that they had are displayed. On the basis of a key word in this chat, attribute objects of the corresponding product, such as the color and shape of the product, are selected and reflected on the product object.

### BACKGROUND OF THE INVENTION

1. Field of the Invention

The present invention relates to a method for managing an imaginary store built on a network such as the Internet, a method for using the store, and a computer-readable recording medium in which an imaginary store managing program is stored; and particularly to a method for managing an imaginary store, wherein a product is sold or marketing is performed by chat between a client and a salesperson, a method for using the store, and a computer-readable recording medium in which an imaginary store managing program is stored.

2. Description of the Related Arts

In recent years, with the spread of the Internet, imaginary stores have increased drastically, which have catalogues, etc. on a server connected to the network. Customers select a product to be bought on a browser and pay out. About imaginary stores, it is unnecessary for clients themselves to move to any store, and it is unnecessary for product suppliers to set up a store actually. Thus, the imaginary stores have advantages that costs for a lot and a building are unnecessary.

In conventional imaginary stores, however, it is difficult to ask instantly questions on products catalogue-displayed on a web and obtain replies. In the case that a client has a question on a product, the client usually uses an electronic mail. However, the electronic mail does not have immediacy. In the case that the reply is insufficient, it is necessary to exchange mails again. This imposes a considerable burden on the client. In the case that a client uses a telephone, if a change of the person in charge is necessary, the client must have the same talk. Such inconveniences arise frequently. Thus, in imaginary stores, it is difficult that a human relation between a salesperson and a client develops as purchase is repeated and complicated communication is made between the salesperson and the client. It is also impossible to understand each other sufficiently. In order to solve such problems, there is suggested a method for communicating the person in charge through chat on an imaginary store (EP 1023672).

Chat on conventional imaginary stores is, however, a process of advancing talk about a product between a salesperson and a client, with using an image of the product displayed on a catalogue as a subject, while displaying a text document on a chat screen. According to such chat based on the text document, the shape, color or the like of the product which is the subject of the chat cannot be specifically indicated. Thus, even if the characteristic of real-time can be obtained by the chat, real explanation on the product is insufficient. As a result, a problem that the client cannot communicate with the salesperson sufficiently arises. Moreover, in conventional imaginary stores, a log of applicants for purchase is recorded but a log of chats is not particularly conscious and this log is not sufficiently used.

### SUMMARY OF THE INVENTION

According to the present invention, there are provided a method for managing an imaginary store, a method for using an imaginary store, and a recording medium wherein an imaginary store managing program is stored, in which a subject product and a chat are caused to be related to each other to attain sufficient communication with a client and a salesperson in the imaginary store, which has a channel for chat on the Internet, and a log of the chat is recorded and is used for marketing.

(Managing method at a server side)

A method for managing an imaginary store on a network such as the Internet, comprising:

a first step of displaying the imaginary store in response to client's request,

a second step of setting a chat channel between a salesperson and the client in response to selection of a product object by the client in the imaginary store, and displaying character data in a chat that they have, and

a third step of selecting an attribute object of a corresponding product on the basis of a key word in the chat and reflecting the attribute object on an image of the product object.

In the imaginary store on the Internet having the chat channel as described above, data can be exchanged between the client and the imaginary store through the chat at a real time. By giving some personality to the person responding to the chat at the store, it is possible to supply reliable relationship similar to selling in an actual store to the client. Moreover, by object oriented chat in which a product is made into an object and the object and the content of the chat are combined and data-managed, reality is given to the chat between the client and the imaginary store. Thus, the selling of the product is made effective. In the second step, when the client selects the salesperson from the initial screen of the imaginary store, the chat channel between the selected salesperson and the client is set. When the client selects the product, the chat channel between a salesperson in charge and the client is set. The third step is a step of displaying plural attributes that can be selected from the product attribute object and reflecting an attribute selected from the plural attributes on the product object. The third step is a step of displaying plural colors (or plural shapes and plural display positions) as the plural attributes that can be selected from the product attribute object and reflecting a specific attribute selected from the plural attributes on the product object. In the case that, for example, clothing is displayed as the product object, the key word “color” in the chat document is clicked with a mouse, attribute selection object representing plural colors that can be selected is displayed. When a specific color is clicked from the colors with the mouse, the color of the clothing, which is the product object, is changed into the selected color.

The imaginary store managing method of the present invention further comprises a fourth step of recording a log of the chat between the client and the salesperson and then analyzing the recorded chat log to perform marketing. The fourth step is a step of extracting a key word from the recorded chat log and dispatching an advertisement corresponding to the extracted key word to a client. In the fourth step, the key word is searched from the content of the client's chat and an advertisement list wherein product data corresponding to the key word and client data are combined is prepared. By analyzing the log of the recorded chat, clients' likes, etc. are analyzed so that marketing such as effective dispatch of an advertisement can be attained. The imaginary store managing method of the present invention further comprises a fifth step of supplying a chat channel between clients using the imaginary store, recording a log of chats, and then analyzing the recorded chat log to perform marketing. In the fifth step, data resulting in purchase of the product is cut out from the chat log between the clients and is collected as data on expansion of selling of the product. Furthermore, in the case that the data resulting in the purchase of the product is cut out from the client's chat log in the step 5, a reward or a privilege is supplied to the client supplying the cut-out data. In this manner, an environment where the clients have a chat on the product is supplied and the reward or the privilege is given to the sender of the chat having a positive content resulting in purchase of the product. By this method, an environment where the client itself promotes selling is made. The imaginary store can promote selling effectively with a little investment.

(Method using an imaginary store at a client side)

A method for using an imaginary store on a network, comprising:

a first step of displaying the imaginary store,

a second step of displaying character data in a chat with a salesperson in a chat channel supplied in response to selection of a product object in the imaginary store, and

a third step of selecting an attribute object of a corresponding product on the basis of designation of a key word in the chat and reflecting the attribute object on an image of the product object.

In the second step in the imaginary store using method, when the salesperson is selected from the initial screen in the imaginary store, a chat with the selected salesperson is made, and when the product is selected, a chat with a salesperson in charge is made. The third step in the imaginary store using method is a step of displaying plural attributes that can be selected from the product attribute object and reflecting an attribute selected from the plural attributes on the product object. For example, the third step is a step of displaying plural colors, plural shapes and plural display positions as the plural attributes that can be selected from the product attribute object and reflecting a specific attribute selected from the plural attributes on the product object. The imaginary store using method further comprises a fourth step of receiving an advertisement corresponding to a key word extracted from a log of the chat recorded in the imaginary store. The imaginary store using method further comprises a fifth step of using a chat channel supplied by the imaginary store to have a chat with another client. In the fifth step, received is a reward or a privilege supplied in the case that data resulting in purchase of the product from the chat log between the clients recorded in the imaginary store is cut out.

(Recording medium)

The present invention also provides a computer-readable recording medium, wherein a program for managing an imaginary store on a network, which is carried out in a computer constituting a server, is stored,

wherein the managing program

a first step of displaying the imaginary store in response to client's request,

a second step of setting a chat channel between a salesperson and the client in response to selection of a product object by the client in the imaginary store, and displaying character data in a chat that they have, and

a third step of selecting an attribute object of a corresponding product on the basis of a key word in the chat and reflecting the attribute object on an image of the product object.

The managing program further comprises a fourth step of recording a log of the chat between the client and the salesperson and then analyzing the recorded chat log to perform marketing. The managing program also further comprises a fifth step of supplying a chat channel between clients using the imaginary store, recording a log of chats, and then analyzing the recorded chat log to perform marketing.

The above and other objects, features, and advantages of the present invention will become more apparent from the following detailed description with reference to the drawings.

### BRIEF DESCRIPTION OF THE DRAWINGS

FIG. 1 is an explanatory view of a network system according to the present invention;

FIG. 2 is a structural view of a hardware of a server machine shown in FIG. 1;

FIGS. 3A and 3B are block views of a function component of an imaginary store according to the present invention;

FIG. 4 is an explanatory view of a top page of the imaginary store according to the present invention;

FIG. 5 is an explanatory view of a top page of persons in charge according to the present invention;

FIG. 6 is an explanatory view of a catalogue page according to the present invention;

FIG. 7 is an explanatory view of a product page based on object oriented chat of the present invention;

FIGS. 8A and 8B are flowcharts of processing of managing an imaginary store according to the present invention;

FIG. 9 is a flowchart of object oriented chat processing in FIGS. 8A and 8B;

FIG. 10 is a flowchart of chat log analysis processing according to the present invention;

FIG. 11 is an explanatory view of a search list of chat logs according to the present invention;

FIG. 12 is an explanatory view of an advertisement mail dispatched on the basis of the search list shown in FIG. 11;

FIG. 13 is a flowchart of advertisement dispatching processing according to the present invention;

FIG. 14 is an explanatory view of a client chat log;

FIG. 15 is an explanatory view of an order form used in an imaginary store;

FIG. 16 is an explanatory view of a mail for thanks to a client; and

FIG. 17 is a flowchart of processing for analyzing chat between clients according to the present invention.

### DETAILED DESCRIPTION OF THE PREFERRED EMBODIMENTS

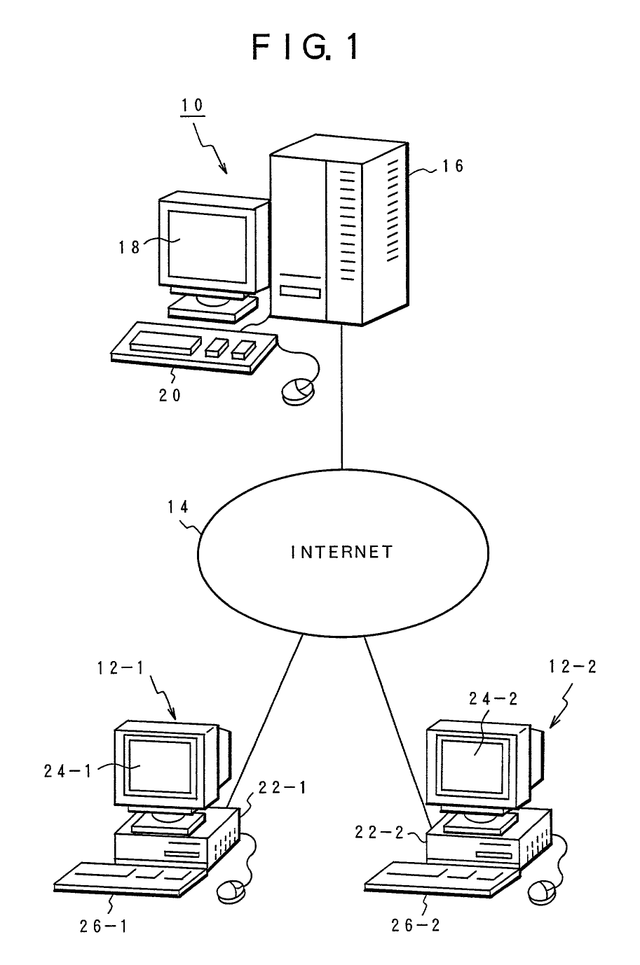

FIG. 1 is an explanatory view of a network system for realizing an imaginary store on the Internet system according to the present invention. A server machine 10 is a computer system for building an imaginary store of the present invention, and is composed of a body 16, a display unit 18 using a color display, and an operation unit 20 having a keyboard and a mouse. To the server machine 10 for building the imaginary store, client machines are connected through the Internet 14. To simplify description, FIG. 1 shows the state that client machines 12-1 and 12-2 are connected to the server machine 10 through the Internet 14. The client machines 12-1 and 12-2 are computer systems that clients who use the imaginary store in the server machine 10 have, and are composed of bodies 22-1 and 22-2, display units 24-1 and 24-2 using color displays, and operation units 26-1 and 26-2 having keyboards and mice, respectively.

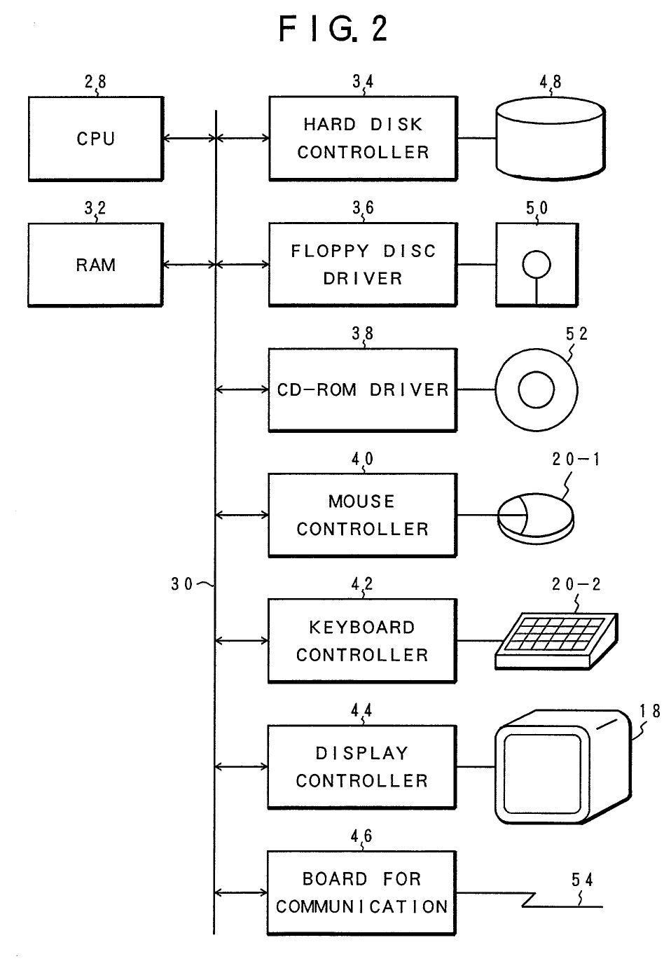

FIG. 2 is a view of an example of the hardware structure of the server machine 10 in the network system shown in FIG. 1. The client machines 12-1 and 12-2 basically have the same structure as shown in FIG. 2. The following are connected to a bus 30 of a CPU 28: a RAM 32, a hard disk controller 34, a floppy disk driver 36, a CD-ROM driver 38, a mouse controller 40, a key board controller 42, a display controller 44 and a communication board 46. The hard disk controller 34 is connected to a hard disk 48, and is loaded with an imaginary store managing program of the present invention. The controller 34 reads the imaginary store managing program from the hard disk driver 48 when the server machine is started, and develops the program in the RAM 32 to carry out the program by the CPU 28. With the floppy disk driver 36, a floppy disk drive 50 is connected, so that the driver 36 reads from and writes on the floppy disk. The CD-ROM driver 38 is connected to a CD driver 52, so that the driver 38 can read data or programs memorized in a CD. The mouse controller 40 transmits input operation through the mouse 20-1 to the CPU 28. The keyboard controller 42 transmits input operation through a keyboard 20-2 to the CPU 28. The display controller 44 performs display on the display unit 18. The board 46 for communication makes possible communication between clients by way of the Internet 14 through a communication line 54.

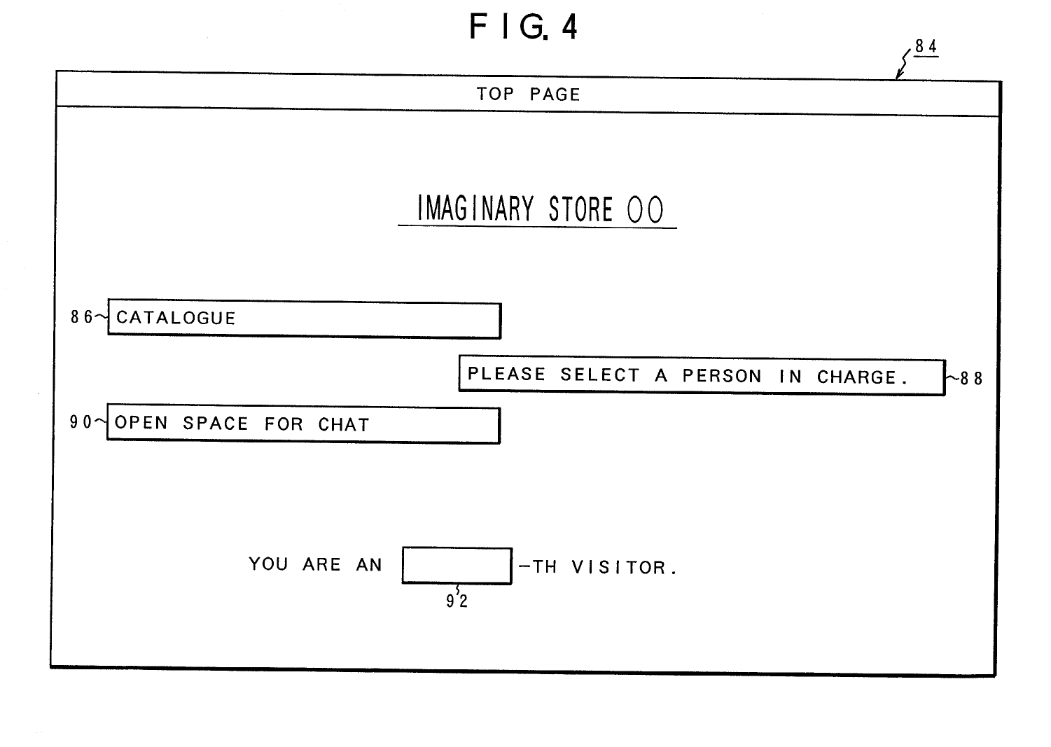

FIG. 4 is a block view showing a function component of the server machine of the present invention, which builds an imaginary store on the Internet, and that of client machines that clients who use the imaginary store on the Internet have. The sever machine 10 for supplying the imaginary store is provided with a WWW server 60, a chat server 62, and an analysis server 64. A memory 66 realized by the RAM 32 in FIG. 2 is provided with a product object memory unit 68, an attribute object memory unit 70, and a key word • object link data 68, a chat log memory unit 74 and a marketing data memory unit 75. The server machine 10 is also provided with display units 18 and operation units 20. In this embodiment, through combination of three display units 18 and three operation units 20, three persons in charge 80-1 to 80-3 deal with clients in the server machine 10. The WWW server 60 in the server machine acts as an object server to supply a catalogue, an order form and other data, which are necessary for managing the imaginary store, as a home page in HTML or XML. In the present invention, not only the WWW server 60 but also chat function based on a chat server 62 are integrated into the imaginary store. In this embodiment, the form that the function of the chat server 62 is included in the WWW server 60 is illustrated, but the two may be united with each other, or may be set up separately to be connected to each other. The chat server 62 is used by clients of the imaginary store on the WWW server 60, and supplies a chat display area on the display page of a specific product object in, for example, a catalogue of the imaginary store, so that any one of the persons in charge 80-1 to 80-3 of the imaginary store on the server machine 10 and a client can have a conversation about the product displayed in a chat format. The chat server 62 in the imaginary store of the present invention has not only a function for supplying a chat channel between a client and any one of the persons in charge but also a function for supplying a chat channel between clients in connection with any product of the imaginary store. The product object memory unit 68 set in the memory 66 memories data on products, which are mainly composed of images and realize a catalogue of the imaginary store on the WWW server 60, in an object format for each product. For this reason, when a client opens a catalogue page of the WWW server 60 and designates a specific product, the product object corresponding to the designated product is read from the product object memory unit 68 and then the image of the product object is displayed, through the display unit 18 of the person in charge in the server machine 10 and the Internet 14, on, for example, the display unit 24-1 on the client machine 12-1 that accesses the server machine 10 at present. Of course, on the screen on which the image of the product object is displayed, the chat display area made by the chat server 62 is simultaneously displayed. In the imaginary store of the present invention, a chat display screen is displayed in the display screen of the product object, and simultaneously a key word is searched from the text document representing the communication content in chat and then attributes of the product object corresponding to the key word are displayed. Examples of the attributes corresponding to the product object include the color of the product, the shape thereof and the position thereof to be watched. These attribute data are caused to be related to the product object and are stored as attribute objects having respective peculiar attribute contents in an attribute object memory unit 70. The corresponding relationship between any one of key words extracted from the text document obtained from chat and the attribute object corresponding to the key word is beforehand registered as a key word • object link data 72. When a key word that is registered in the key word • object link data 72 makes its appearance in chat, the key word is subjected to, for example, color-reversible display or flicker display to make the key word notable. A person in charge or a client designates or selects the key word that is notably displayed by clicking the mouse, the corresponding attribute object is read from the attribute object memory unit 70, with reference to the key word • object link data 72, to reflect the attribute object on the product object displayed at the present time. That is, it can be said that the display of the product object of the present invention is object oriented chat, in which the relationship between the text document of chat and the object has a link relationship. The object oriented chat supplied according to the present invention is classified into direct object oriented chat and indirect object oriented chat. In the direct object oriented chat, on the basis of a key word in chat, any attribute object is directly selected and is reflected on the product object. On the other hand, the indirect object oriented chat is a method of designating an attribute through plural steps. For example, an attribute selection object is first displayed to select plural attributes, correspondingly to a key word extracted from chat. When the person in charge or the client designates a specific attribute in the attribute selection object, the attribute object corresponding to the designated attribute is reflected on the product object 68. Specifically, in the case that, for example, the key word “color” is extracted from the text document in chat, the attribute selection object representing plural colors that can be reflected on the product object is first displayed as an attribute selection object, correspondingly to the key word “color”. The person in charge or the client selects any one of the colors in the displayed attribute selection object, so that the designated color is reflected on the product object. As described above, in the imaginary store of the present invention, the client and the salesperson have a communication with each other in a chat format while they watch the image of a product displayed as a product object by object oriented chat. The content of the chat is reflected on the object by link of the attribute object based on a key word that appears in the communication. As a result, a situation like product-transaction that is similar to negotiation in an actual store can be realized by the imaginary store. The chat between the person in charge and the client, based on the object oriented chat supplied by the imaginary store in the server machine 10, is kept as a log. At the time of the end of the chat, the log is caused to be related to the product object and is memorized in the chat log memory unit 74. This chat log memory unit 74 memorizes not only the log of chats between the person in charge and clients but also the log of chats between clients, which is supplied by the imaginary store of the present invention. The analysis server 64 makes an analysis necessary for marketing on the chat log memorized in the chat log memory unit 74, and memorizes the analysis results in the marketing data memory unit 75. In the analysis of the chat log by the analysis server 64, for example, a key word related to the product is searched from the chat log of clients. An advertisement list wherein the product data corresponding to the searched key word and client data are combined is prepared. A report corresponding to a key word extracted on the basis of the advertisement list is dispatched to clients. Such marketing is performed. About the analysis of the chat log between clients, the analysis server 64 cuts out data resulting in product purchase from the chat log between clients, and collects the data as product selling expanding data, and supplies a reward or a privilege to a client who had the chat from which the cut-out data resulting in product purchase is supplied. In this manner, at the side of the imaginary store, advertisement effect between clients in the chat between the clients is made good use of, so that selling can be promoted. The client machines 12-1 and 12-2 connected to the server machine 10 for supplying the imaginary store in the network through the Internet 14 are provided with WWW browsers 76-1 and 76-2 and chat clients 78-1 and 78-2, respectively. The function of the client machines 12-1 and 12-2 is reference function itself of home pages built in the server machine 10 on the Internet 14, and can be specifically realized by web page reference function of Explore by Microsoft. In the case that the client machine 12-1 accesses the server machine 10 supplying the imaginary store, a chat channel is set up when the home page of the imaginary store is read and simultaneously a catalogue is designated. Thus, functions of the chat clients 78-1 and 78-2 are set up in the client machines 12-1 and 12-2. About product objects, the clients and the person in charge in the server machine 10 can have a conversation in a chat format. A chat channel is also set up between the client machines 12-1 and 12-2, so that clients 82-1 and 82-2 can have a chat through the chat channel of the imaginary store, separately from the imaginary store.

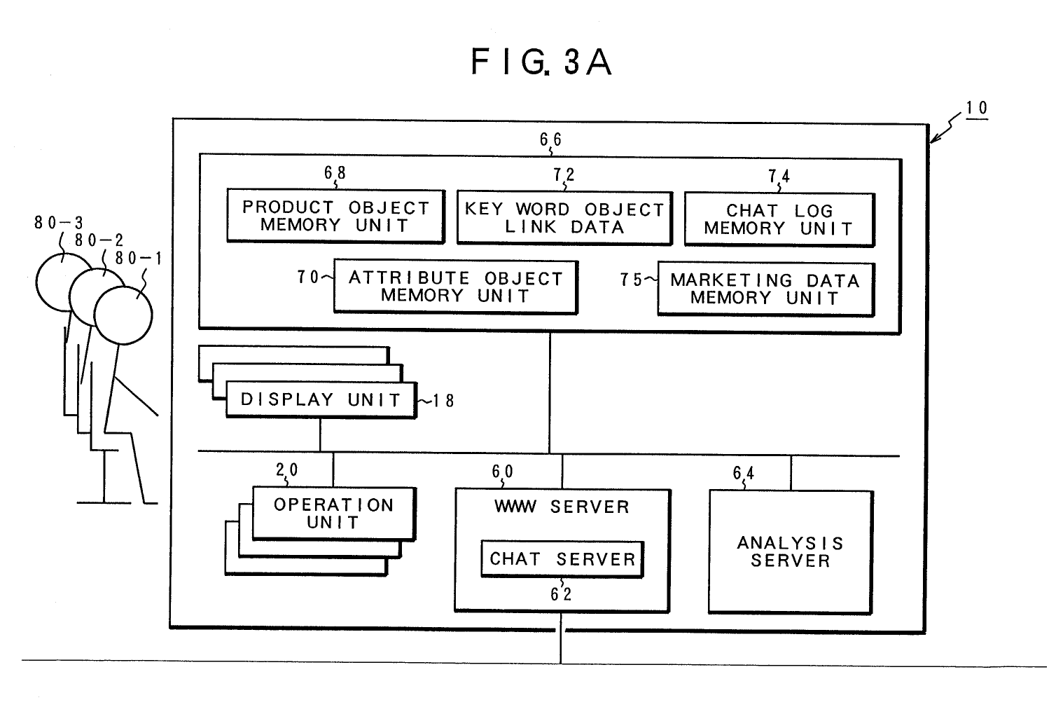

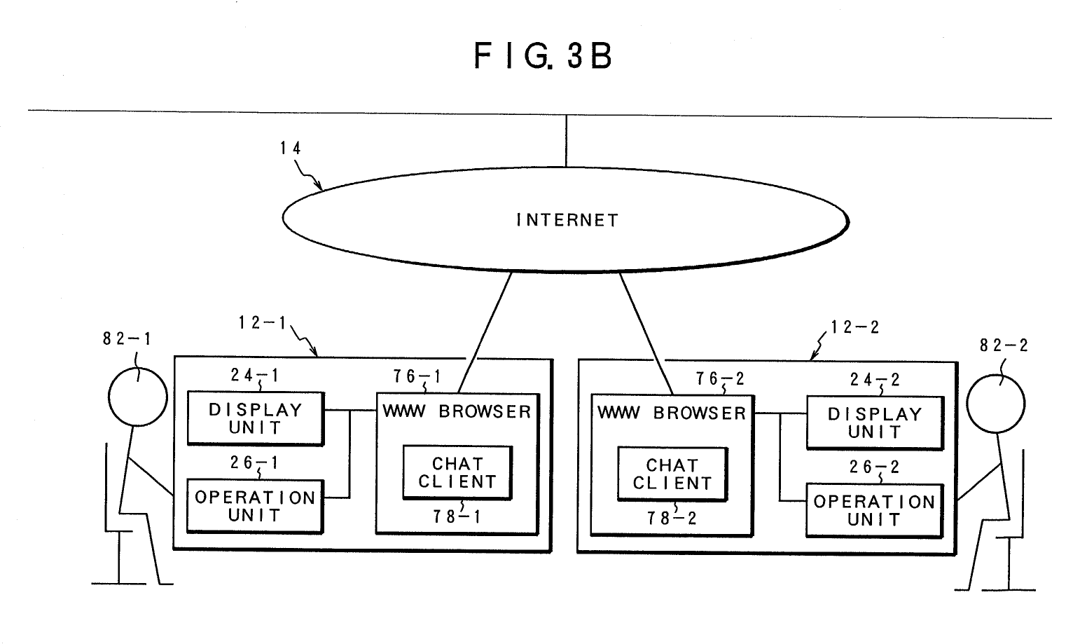

FIG. 4 is a view of an example of a top page 84 first displayed when the client 82-1 of the client machine 12-1 in FIGS. 3A and 3B access the imaginary store in the server machine 10. On this top page 84, a catalogue 86, the wording 88 “please select a person in charge”, an open space 90 for chat, and an access counter 92 are displayed in indexes. When the client wants to watch products in the imaginary store, the client clicks the catalogue 86 with a mouse. When the client does not select any product and wants to ask directly to a person in charge, the client should click the wording 88 “please select a person in charge”. When the client wants to have a chat with another client, the client should select the open space 90 for chat.

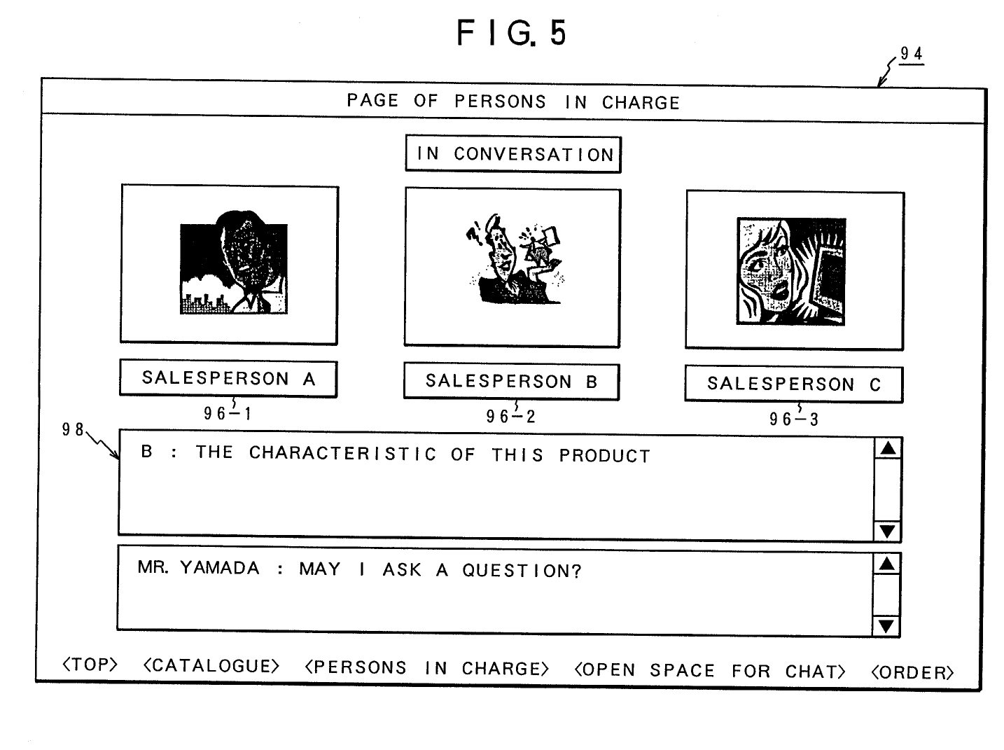

FIG. 5 is a view of an example of a page 94 of persons in charge displayed when the wording 88 “please select a person in charge” is clicked on the top page shown in FIG. 4. On the page 94 of the persons in charge, characters and names are used to display boxes 96-1, 96-2 and 96-3 for selecting a person in charge. If the client clicks salesperson B in the selection box 96-2, a chat display area 98 below it is used so that designated salesperson B and the client, for example, Mr. Yamada can have a conversation in a char format.

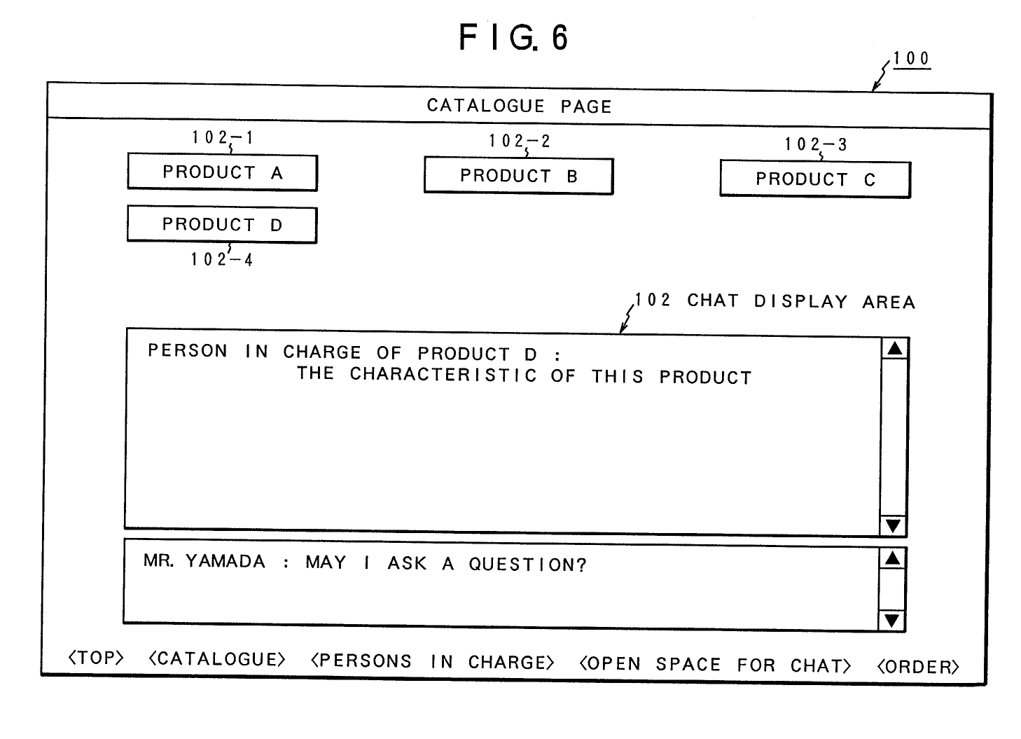

FIG. 6 is a view of a catalogue page 100 displayed in the case that the catalogue 86 is clicked on the top page shown in FIG. 4. On this catalogue page 100, for example, product indexes 102-1 to 102-4 are displayed. When the client selects, for example, a product D in the product index 102-4, a chat display area 102 is displayed below it so that the client and the person in charge of the product D can have a conversation in a chat format. In other words, in the object oriented chat of the present invention, the client can enter dealings in the imaginary store through either one of two routes, that is, by either selecting a salesperson or selecting a product on the top page.

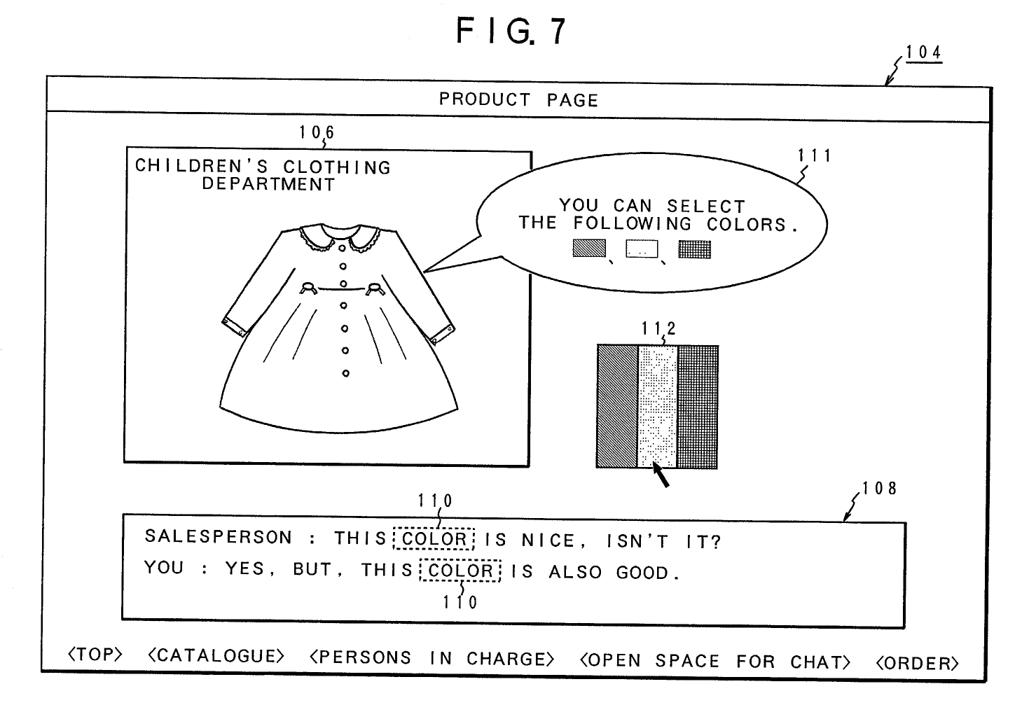

FIG. 7 is a view of an example of a specific product page 104, based on object oriented chat of the children's present invention. On this product page 104, children's clothing is selected as a product object and an image of the clothing is displayed as a product object in an object display area 106. A chat display area 108 is displayed below the object display area 106. The chat that a salesperson and a client had is displayed as a text document. About the children's clothing as a product object displayed in the object display area 106, the key word used in the key word • object link data 72 is searched in the text document in the chat display area 108. In the case that, for example, the key word “color” is registered, the word “color” that is equal to the key word and is present in the chat display area 108 is displayed in color that is different from usual display color. When the usual display color is, for example, black, the word “color” is displayed in red. Alternatively, the key word “color” is subjected to reversible display or flicker display. In this manner, the salesperson and the client recognize the word 110 “color” in the chat display area 108 as a key word. When this key word 110 is clicked with the mouse, at the right side of the object display area 106, for example, 3 colors that can be reflected as an attribute selection object 112 on the product object are displayed. Following the selection of the key word 110, the wording “you can select the following: ◯◯, □□, and ΔΔ” is displayed in a balloon 111 for the product object. This is a display of the attribute selection object making it possible to select plural colors reflected on the product object. Therefore, when the central color in the attribute selection object 112 representing three colors is clicked with the mouse, the selected color is reflected on the display color of the product object in the object display area 106 and the display color is changed. Incidentally, by selecting and designating the key word “color” in the chat display area 108, the attribute selection object 112 is displayed. However, in the case that a specific color, for example, a key word “red” is present in the text document, the color represented by the key word “red”, which is the selected attribute, is directly reflected on the clothing of the product object in the object display area 106 when the key word “red” is selected. Thus, the color of the clothing is changed. Such change of the attribute based on the attribute selection of the product object can also be performed, about not only the color but also the shape of the product object or the position thereof to be watched. In the bottom column of each of pages shown in FIGS. 6, 7 and 8, selection areas <top>, <catalogue>, <persons in charge>, <open space for chat> and <order> are set up. Thus, the client can shift to an arbitrary page if necessary.

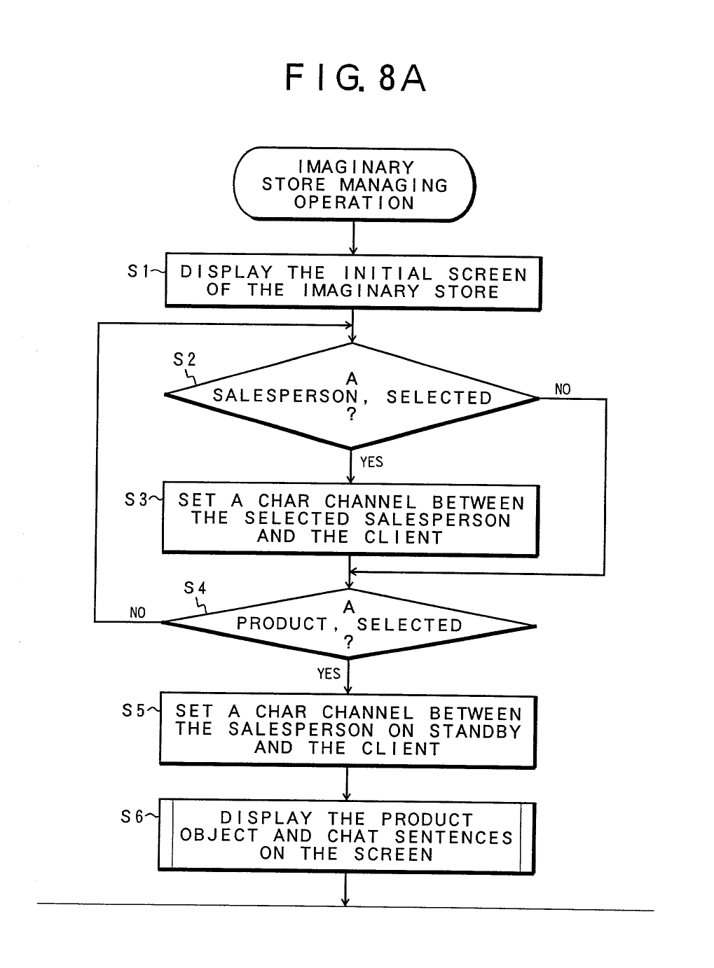

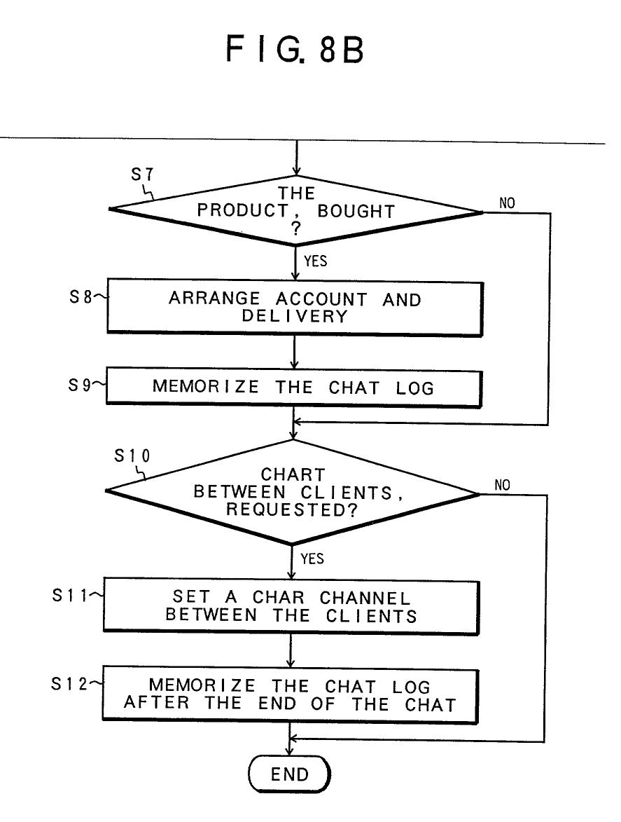

FIGS. 8A and 8B are flowcharts of processing of managing the imaginary store, which is supplied by the WWW server 60 and the chat server 62 shown in FIGS. 3A and 3B, according to the present invention. In step S1, to access of a client, the imaginary store in the server machine 10 first displays, for example, a top page as shown in FIG. 5 as an initial screen of the imaginary store. If in the state that this top page is displayed a salesperson is selected in step S2, a chat channel between the selected salesperson and the client is set up in step S3 and then the screen is shifted to the page of the person in charge, shown in FIG. 5, in order to start commercial transaction. If no salesperson is selected, it is checked in step S4 whether a product is selected. If a product is selected, the screen is shifted to a catalogue page as shown in FIG. 6 instep S5 to set up a chat channel between the salesperson in charge of the product and the client. In the state that the chat channel is set between the product object and the salesperson in this manner, the present processing goes to step S6. In step S6, while the product object and the chat document are displayed in the screen, for example, a product page as shown in FIG. 8 is supplied. Thus, commercial transaction between the salesperson and the client is carried out in the imaginary store through the object oriented chat. It is checked in step S7 whether the client purchases the product in the imaginary store through the object oriented chat, that is, the client orders the product. When the product is ordered, the processing advances to step S8. In step S8, account and dispatch are arranged and subsequently the chat log is caused to be related to the product object purchased in step S9 and is memorized in the chat log memory unit 74. On the other hand, in the case that chat between clients is requested in step S10, a chat channel is set up between the clients in step S1. When the chat is ended, the chat log is memorized in the chat log memory unit 74 in step S12.

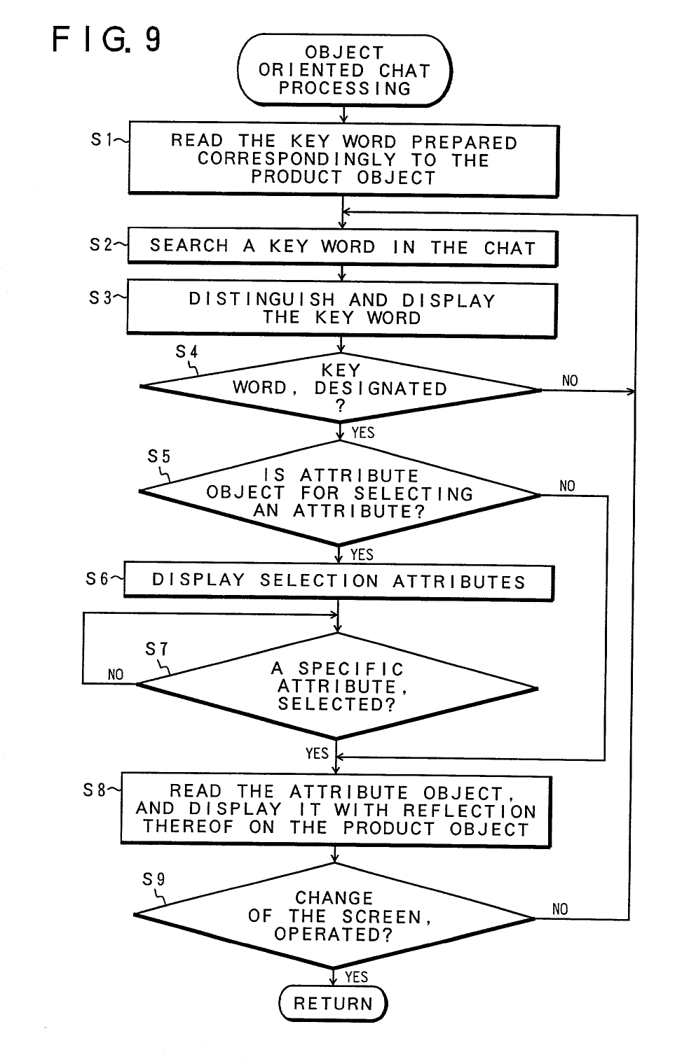

FIG. 9 is a flowchart of the object oriented chat processing in step S6 in FIG. 8A, wherein the product object and the chat document are displayed. In this object oriented chat processing, a key word prepared in the key word • object link data 72, correspondingly to the product object, is read as a template in step S1. In step S2, the key word is searched in the chat. When the key word makes its appearance in the chat, the key word is distinguished by and displayed with a change in its color, flicker, reversion or the like in step S3. When this distinguished and displayed key word is designated in step S4, the present processing advances to step S5 so that it is checked whether the attribute object is for selecting an attribute. When the attribute object is for selecting an attribute, the attribute selection object is displayed in step S6. Subsequently, in step S7, the present processing waits for selection of a specific attribute in the attribute selection object. In step S8, the selected attribute object is read and is reflected on the product object and displayed. On the other hand, in the case that in step S5 the attribute object is not for selecting any attribute and is a key word which directly designates an attribute object, the processing advances to step S8 so that the selected attribute object is read and reflected on the product and displayed. The steps S1 to S8 are repeated until the change of the screen is operated in step S9. In the object oriented chat processing shown in FIG. 9, in the case that the key word in the chat is searched and then distinguished and displayed, after the person in charge or the client designates the key word the attribute object is reflected thereon and displayed. However, without waiting for the designation of the key word by the person in charge or the client, the attribute object may be automatically displayed. It is however necessary that the client recognizes the change of the attribute by automatic selection of the key word; it is therefore desired that the client can select whether the reflection of the attribute object is in an automatic mode or in a manual mode. The imaginary store managing processing shown in FIGS. 8A and 8B has the premise that even if a client accesses the imaginary store from either the page of persons in charge shown in FIG. 5 or the page of a catalogue shown in FIG. 6, a person in charge who can respond to the client is present. However, in the case that any person in charge is not free, it is desired that the client's question can be automatically answered. Namely, for every pattern of clients' questions to the imaginary store in a chat format, a data base for automatic reply is prepared. At a real time, a question present in the data base can be automatically answered in a chat format, using the answer text prepared in the data base. In this manner, during a time until a salesperson becomes free, the client makes questions to some extent, using the automatic answer function, without waiting for an opportunity. In a short time, the salesperson becomes free and then the client can enter chat with the salesperson. In the state that plural clients wait using the automatic answer function, the server displays clients' waiting order. Immediately after the person in charge becomes free, the person opens a chat channel with the client who is waiting for a longest time and deals with the client. In this manner, even if the imaginary store is crowded, any client can at least have a chat using the automatic answer function and can acquire a situation equivalent to actual stores, for example, a situation that the client waits for salesperson's response while watching a catalogue.

The following will describe processing for performing marketing by analyzing chat logs by the analysis server 64 provided in the server machine 10 of FIGS. 3A and 3B. The analysis server 64 reads the chat logs between the salesperson and clients memorized in the chat log memory unit 74, searches a key word from the chat log content, prepares an advertisement list wherein product data corresponding to the key word and client data are combined, and dispatches an advertisement corresponding to the key word on the basis of this advertisement list to clients. Such marketing is performed.

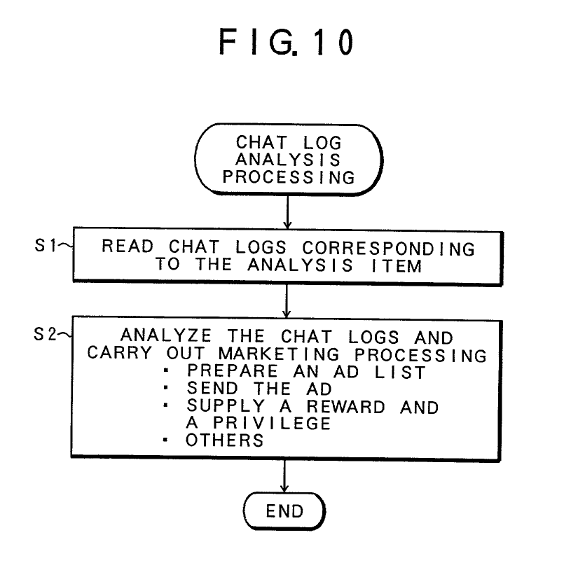

FIG. 10 is a flowchart of chat log analysis processing by the analysis server. In step S1, chat logs corresponding to an analysis item are first read. As the analysis item, an appropriate item as follows can be designated: attributes such as a product, clients' ages or jobs, or a period. Chat logs corresponding to the thus designated analysis item are read from the chat log memory unit 74. Thereafter, the chat logs are analyzed in step S2 to perform marketing processing. Examples of the marketing processing by the analysis of the chat logs include preparation of an advertisement list, dispatch of an advertise, and supply of a reward or a privilege to a client contributing to the expansion of selling of a product.

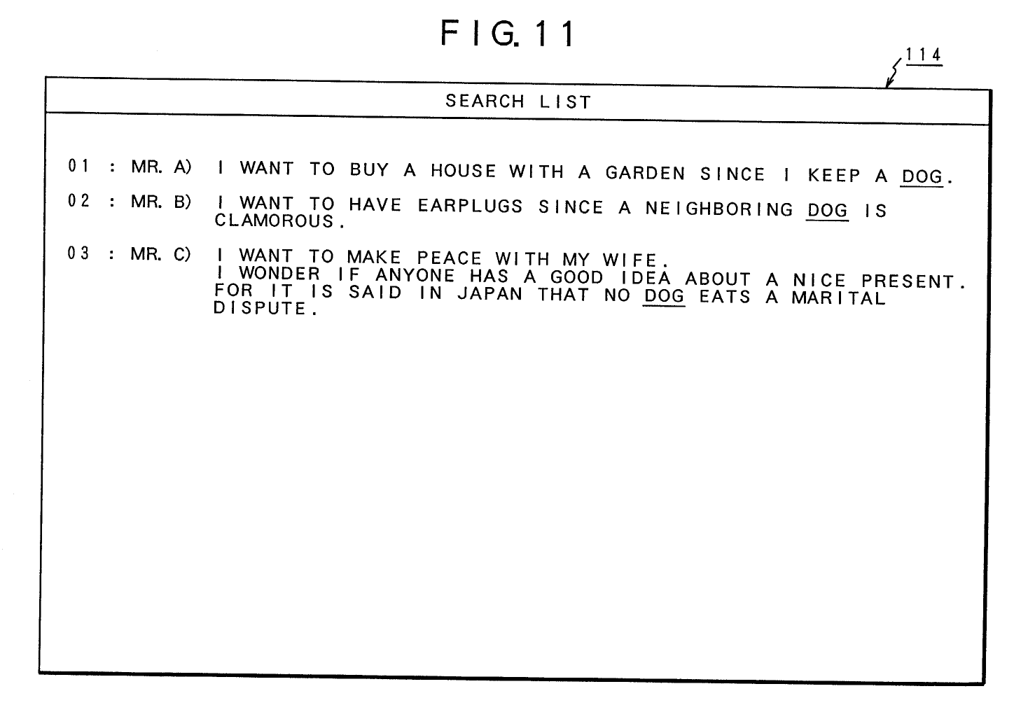

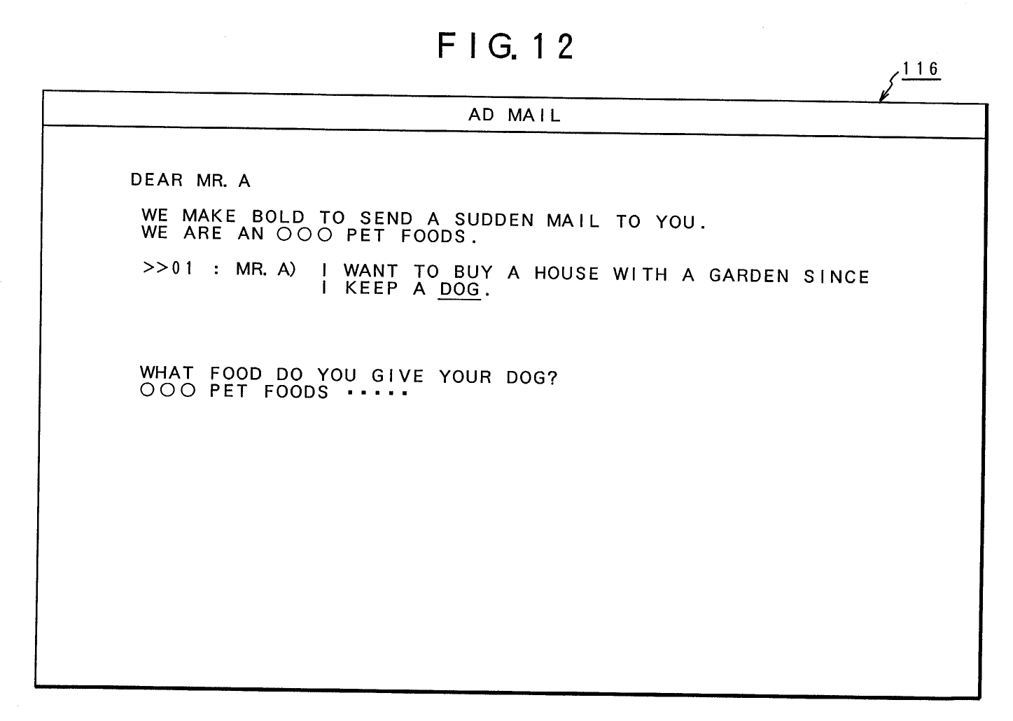

FIG. 11 is a view of a specific example of the preparation of an advertisement list and the dispatch thereof in the chat log analysis processing shown in FIG. 10. In the analysis server, the word “dog” is designated as a key word of the analysis item, and then chat logs are searched. As a result, for example, search results as shown in a search list 114 are obtained. Among the search results in this search list 114, Mr. A's (list number: 01) chat log is the content that can be used for dispatch of an advertisement about the key word “dog”. Mr. B's (list number: 02) chat log and Mr. C's (list number: 03) chat log have the key word “dog”, but are unsuitable for dispatch of an advertisement. From the search list 114, therefore, Mr. A, who is the client corresponding to the key word “dog”, can be specified as a search result. To Mr. A specified as this search result, an advertisement is dispatched through an advertisement mail 116 as shown in, for example, FIG. 12 by a maker of pet food.

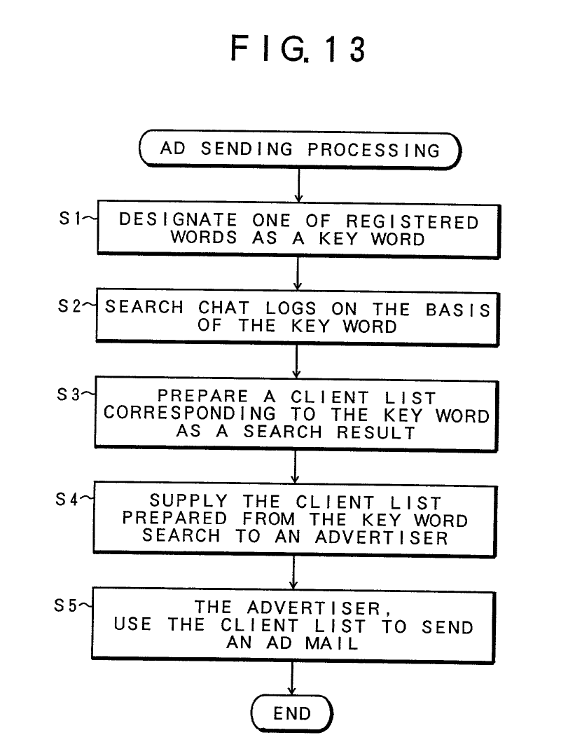

FIG. 13 is a flowchart of advertisement dispatching processing based on the analysis result of the analysis server of the present invention. In step S1, one of registered words is first designated as a key word. In step S2, chat logs are searched on the basis of the key word. In step S3, a client list corresponding to the key word is prepared as a search result. Subsequently, in step S4, the client list obtained by the search with the key word is supplied to an advertiser. In step S5, the advertiser uses the client list to dispatch advertisement mails. The preparation of the client list from the chat logs and the dispatch of the advertisement mails on the basis of the client list in the advertisement dispatching processing may be performed in the server machine 10 shown in FIGS. 3A and 3B. Alternatively, the steps until the advertisement list is prepared are performed in the server machine 10 and this advertisement list may be supplied to another advertisement dispatching server to dispatch advertisement mails.

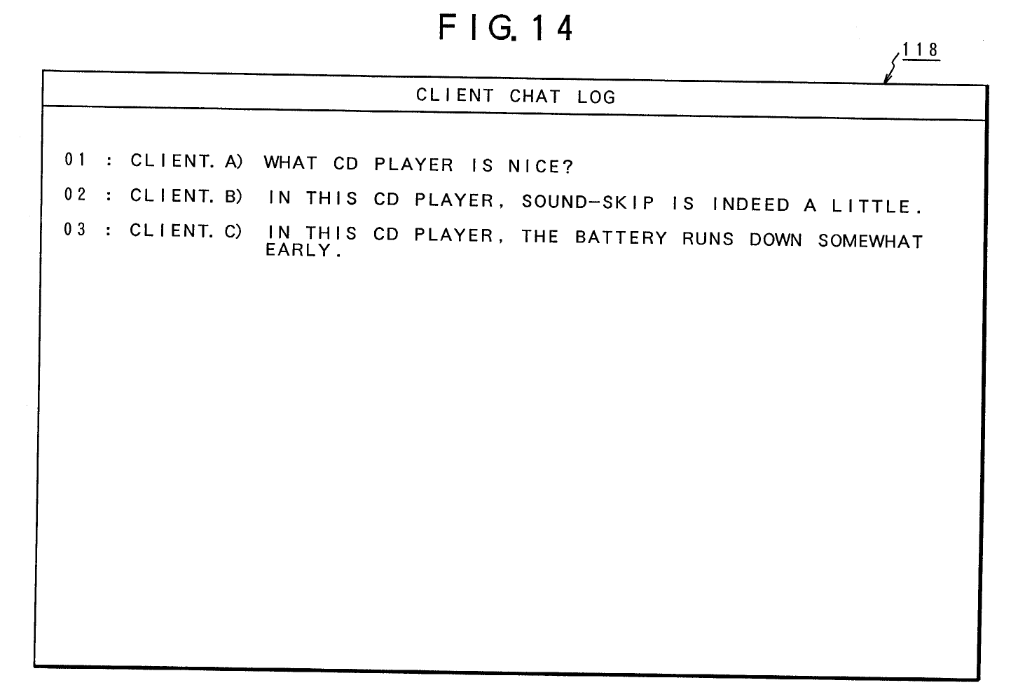

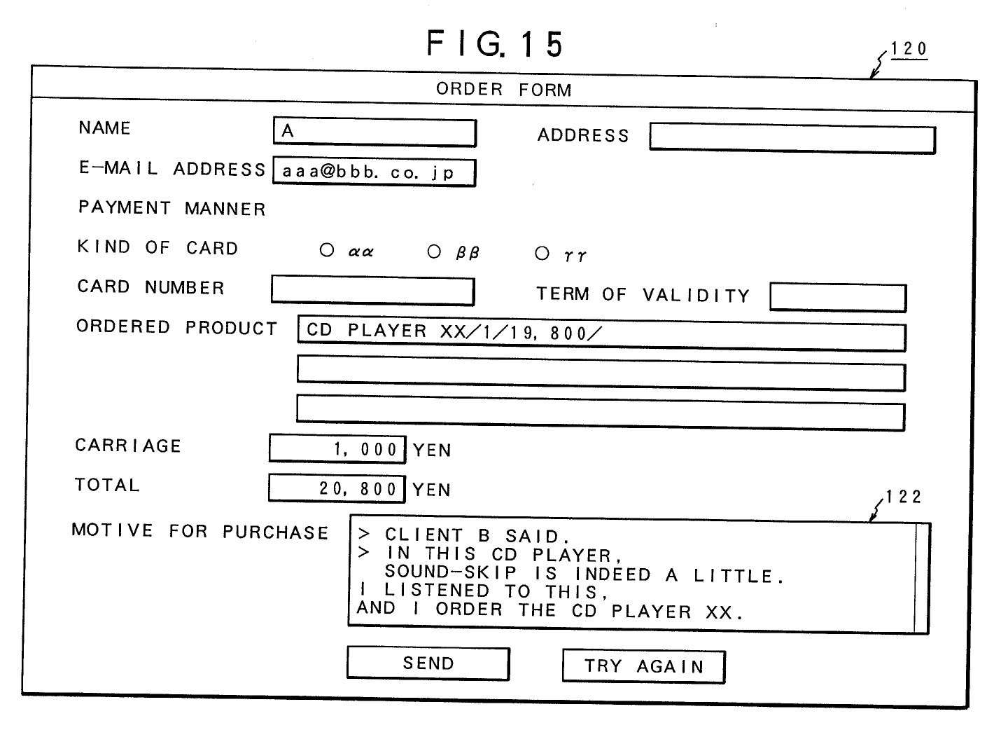

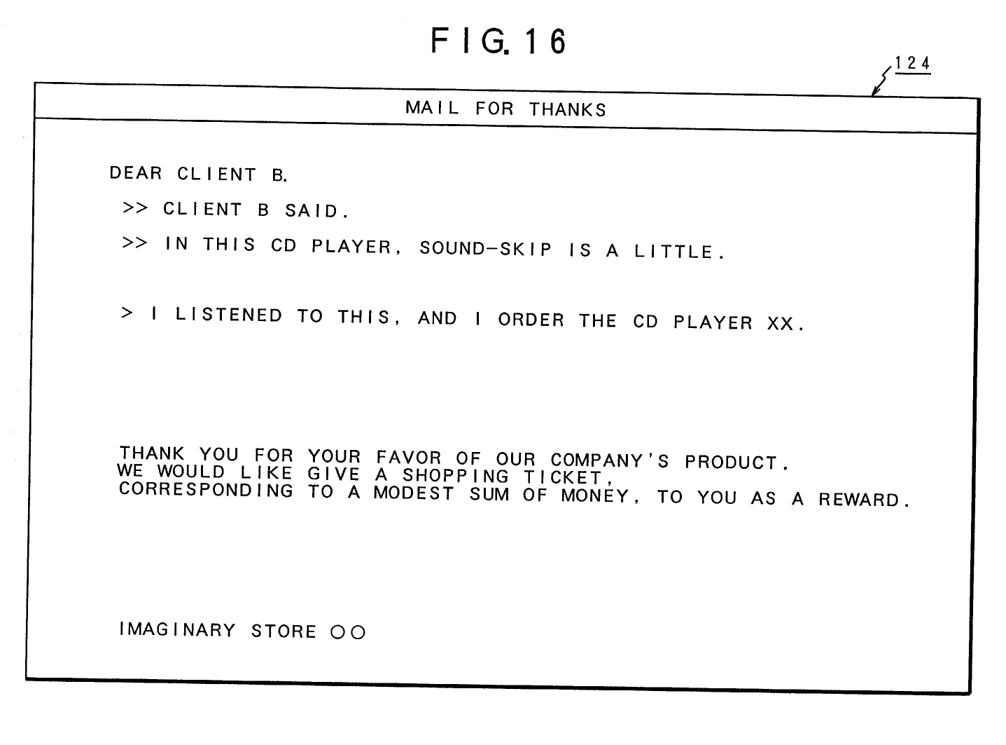

The following will describe processing for supplying a reward or a privilege to a supplier of a chat log who supplies data effective for expansion of selling of a product from analysis results of chat logs by the analysis server 64. FIG. 14 is a view showing search results of a client chat log 118 resulting in selling of a product in the imaginary store. Clients A, B and C have a chat about purchase of a CD player. On the basis of the results of this chat log, for example, the client A dispatches an order form 120 to the imaginary store as shown in FIG. 15. The order form 120 has boxes in which a name, an address, an E-mail address, a payment manner and an ordered product are to be entered, and a box 122 below them in which a motive for purchase is to be entered. In the box 122 for a motive for purchase, the client A states that the client B's proposal in the chat among the clients is a motive for purchase. That is, it can be understood from the analysis results of the chat log that the client A purchases a CD player on the basis of the client B's chat “in this CD player, sound-skip is a little”. Thus, to the client B, who is a person dispatching the chat directly resulting in the selling of the product, a mail 124 for thanks as shown in FIG. 16 is dispatched. In this case, as a reward “a shopping ticket” is supplied. Of course, it is allowable to supply a privilege such as a point service or a discount, besides “the shopping ticket” as a reward. By analyzing chats on a product between clients in this manner and supplying a reward or a privilege to a person who dispatches the chat resulting in purchase of the product, the imaginary store can receive benefit of propaganda promotion by the client per se. The client B, who received the mail 124 for thanks as shown in, for example, FIG. 16, recognizes that if he/she has a chat resulting in purchase of a product in the imaginary store, he/she can receive a reward from the imaginary store and positively takes part in a chat between clients to supply effective data resulting in purchase of a product to another client. The above-mentioned embodiment is an example in which as marketing based on analysis of memory of chat logs, an advertisement is dispatched or a reward is supplied to a sender of selling-promotion data, but examples of the marketing based on analysis of chat logs include appropriate analysis processing other than the above. For example, plural analysis items such as a product item, an age, a period are designated to summarize chat logs as a table, and then this table is supplied to an on-line analysis tool to be analyzed. Mining processing using the analyzed results is performed to find out useful data which are hidden in the chat log.

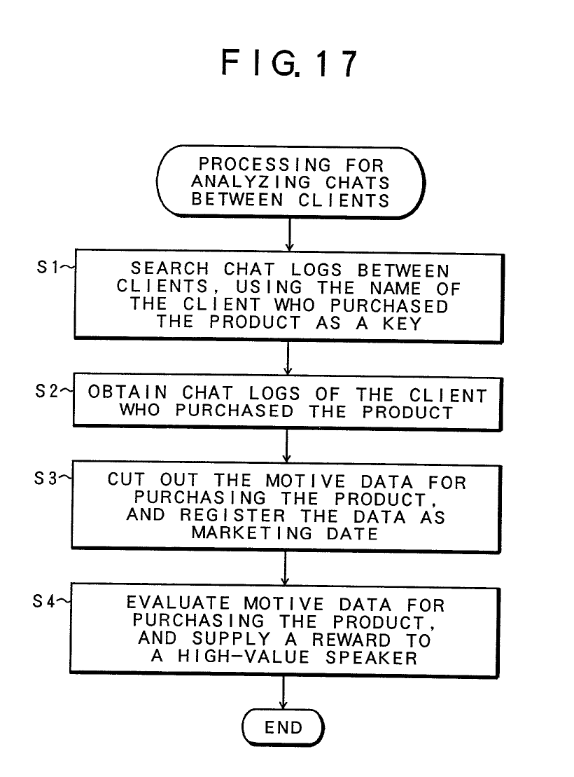

FIG. 17 is a flowchart of processing for analyzing chats between clients according to the present invention. In step S1, chat logs between clients are searched using the name of client who purchased a product as a key. In step S2, chat logs are obtained as search results. Subsequently, in step S3, the obtained chat logs are examined to cut out a text document that has become a motive for purchasing the product. The cut document is registered in marketing data. In the case of, for example, the order form shown in FIG. 16, the analysis result “recommendation by clients” is attached to the cut text document and the document is registered. In step S4, a reward or a privilege is supplied to the speaker supplying data that have become a motive for purchasing the product through a mail or the like.

The following will describe a recording medium in which an imaginary store managing program that will be installed in the server according to the present invention is stored. The imaginary store managing program of the present invention is memorized in a memory medium that can be carried, such as CD-ROM or a floppy disk. The memory medium is set in the CD-ROM driver 38 or the floppy disk driver 36 in the server machine 10 having the hardware construction shown in FIGS. 3A and 3B, and then the program is installed and memorized in the hard disk driver 48. The program is developed into the RAM 32, which is a main memory, and is carried out by the CPU 28 to realize a function as an imaginary store.

The imaginary store managing program of the present invention may be recorded in a recording medium for other machines connected to a network and down-loaded/obtained through a communication control device in order to store the program in an auxiliary memory device or a main memory device of any machine.

The imaginary store managing program, which is stored in a memory medium, of the present invention basically comprises:

(I) a first step of displaying an imaginary store on a screen;

(II) a second step of using a chat screen displayed correspondingly selection of a product object image in the imaginary store to have a chat with a salesperson; and

(III) a third step of selecting an attribute object of a corresponding product on the basis of a key word on the chat screen and then reflecting the attribute object on the product object.

The imaginary store managing program may comprise a fourth step and a fifth step. The fourth step is a step of preparing an advertisement list wherein product data corresponding to a key word extracted from chat logs recorded in the imaginary store and client data are combined, and then dispatching the advertisement. The fifth step is a step of cutting out data resulting in purchase of a product from chat logs between clients using the imaginary store, collecting the data as data on expansion of selling of the product, and supplying a reward or a privilege to the client who supplied the cut-out data resulting in the selling expansion of the product. More specifically, the imaginary store managing program for attaining the processing of the flowcharts shown in FIGS. 8A, 8B and 9 correspond to the managing program having the first and third steps. The flowchart of the advertisement dispatching processing shown in FIG. 13 corresponds to the fourth step, and the flowchart of processing for analyzing chats between clients shown in FIG. 18 corresponds to the fifth step. On the other hand, it is sufficient that the client machines 12-1 and 12-2 have a WWW browser that can access and use the imaginary store in the server machine, if the imaginary store managing program is installed in the server machine and carried out. Thus, in the client machines it is unnecessary that any special program is installed.

As described above, according to the present invention, real-time data exchange between an imaginary store on the Internet and a client thereof can be performed in a chat format. Moreover, in this chat, a product object and its attribute object are linked to each other on the basis of a key word in the chat, so that an image, a shape, a position to be watched or the like can be reflected on the product object. In such an object oriented chat, reality can be given to the chat between the client and the imaginary store, so that the product can be effectively sold. Furthermore, in the present invention, a chat log between a salesperson and a client is recorded and the recorded chat log is analyzed to perform marketing. Thus, clients' likes can be analyzed and marketing such as effective dispatch of an advertisement can be attained. Additionally, a chat channel between clients is supplied and the record of chat logs between clients is analyzed, so that a reward or a privilege can be supplied to a sender of a chat having a positive content resulting in purchase of a product. In this way, it is possible to make an environment wherein clients themselves promote selling, or realize effective expansion of selling at low costs by the imaginary store.

The above-mentioned embodiment is related to an example wherein the imaginary store is a store where clothing is sold. However, the present invention can be applied to any store, where the kind of handled products is not limited. The present invention also includes various modifications so far as the objects and advantages of the present invention are not damaged. The present invention is not limited to any numerical limitations in the embodiment.

What is claimed is:

1. A method for managing an imaginary store on a network, comprising:
a first step of displaying the imaginary store in response to client's request,
a second step of setting a chat channel between a salesperson and the client in response to selection of a product object by the client in said imaginary store, and displaying character data in a chat that they have, and
a third step of selecting an attribute object of a corresponding product on the basis of a key word in said chat and reflecting the attribute object on an image of said product object.

2. The method according to claim 1, wherein in said second step, when the client selects the salesperson in the imaginary store, the chat channel between the selected salesperson and the client is set, and when the client selects the product, the chat channel between a salesperson in charge and the client is set.

3. The method according to claim 1, wherein said third step is a step of displaying plural attributes that can be selected from said product attribute object and reflecting an attribute selected from said plural attributes on an image of said product object.

4. The method according to claim 2, wherein said third step is a step of displaying plural colors, plural shapes and plural display positions as the plural attributes that can be selected from said product attribute object and reflecting a specific attribute selected from said plural attributes on an image of said product object.

5. The method according to claim 1, which further comprises a fourth step of recording a log of the chat between said client and the salesperson and then analyzing the recorded chat log to perform marketing.

6. The method according to claim 5, wherein said fourth step is a step of extracting a key word from the recorded chat log and dispatching an advertisement corresponding to the extracted key word to a client.

7. The method according to claim 5, wherein in said fourth step, the key word is searched from the content of the client's chat and an advertisement list wherein product data corresponding to the key word and client data are combined is prepared.

8. The method according to claim 1, which further comprises a fifth step of supplying a chat channel between clients using the imaginary store, recording a log of chats, and then analyzing the recorded chat log to perform marketing.

9. The method according to claim 8, wherein in said fifth step data resulting in purchase of the product is cut out from the chat log between the clients and is collected as data on expansion of selling of the product.

10. The method according to claim 9, wherein in the case that said data resulting in the purchase of the product is cut out in the step 5, a reward or a privilege is supplied to the client supplying the cut-out data.

11. A method for using an imaginary store on a network, comprising:
a first step of displaying the imaginary store,
a second step of displaying character data in a chat with a salesperson in a chat channel supplied in response to selection of a product object in said imaginary store, and
a third step of selecting an attribute object of a corresponding product on the basis of designation of a key word in said chat and reflecting the attribute object on an image of said product object.

12. The method according to claim 11, wherein in said second step, when the salesperson in the imaginary store is selected, a chat with the selected salesperson is made, and when the product is selected, a chat with a salesperson in charge is made.

13. The method according to claim 11, wherein said third step is a step of displaying plural attributes that can be selected from said product attribute object and reflecting an attribute selected from said plural attributes on an image of said product object.

14. The method according to claim 11, wherein said third step is a step of displaying plural colors, plural shapes and plural display positions as the plural attributes that can be selected from said product attribute object and reflecting a specific attribute selected from said plural attributes on an image of said product object.

15. The method according to claim 11, which further comprises a fourth step of receiving an advertisement corresponding to a key word extracted from a log of the chat recorded in said imaginary store.

16. The method according to claim 11, which further comprises a fifth step of using a chat channel supplied by the imaginary store to have a chat with another client.

17. The method according to claim 16, wherein in said fifth step, received is a reward or a privilege supplied in the case that data resulting in purchase of the product from the chat log between the clients recorded in the imaginary store is cut out.

18. A computer-readable recording medium, wherein a program for managing an imaginary store on a network, which is carried out in a computer constituting a server, is stored,
wherein said managing program
a first step of displaying the imaginary store in response to client's request,
a second step of setting a chat channel between a salesperson and the client in response to selection of a product object by the client in said imaginary store, and displaying character data in a chat that they have, and
a third step of selecting an attribute object of a corresponding product on the basis of a key word in said chat and reflecting the attribute object on an image of said product object.

19. The recording medium according to claim 18, which further comprises a fourth step of recording a log of the chat between said client and the salesperson and then analyzing the recorded chat log to perform marketing.

20. The recording medium according to claim 18, which further comprises a fifth step of supplying a chat channel between clients using the imaginary store, recording a log of chats, and then analyzing the recorded chat log to perform marketing.
